(19) United States
(12) Patent Application Publication
(10) Pub. No.: US 2007/0241603 A1
(43) Pub. Date: Oct. 18, 2007

(54) Armrest Locking Mechanism

(75) Inventor: Jurgen Otto, Burscheid (DE)

Correspondence Address: FOLEY & LARDNER LLP, 777 EAST WISCONSIN AVENUE, MILWAUKEE, WI, 53202-5306, US

(73) Assignee: Johnson Controls GmbH

(21) Appl. No.: 10/590,943

(22) PCT Filed: Feb. 25, 2005
(86) PCT No.: PCT/EP05/02037

§ 371 Date: Jun. 21, 2007

(30) Foreign Application Priority Data
Mar. 5, 2004 (DE) 10 2004 011 385.8

(51) Int. Cl. B60N 2/46; G05G 11/00

(52) U.S. Cl. 297/411.38; 74/479.01

(57) ABSTRACT

An adjustment device for a vehicle component includes a first locking toothing and a rocking lever, the rocking lever being able to be set in a stable locking position and a stable release position as a result of a control element acting on a spring.

### CROSS-REFERENCE TO RELATED PATENT APPLICATIONS

The present Application claims the benefit of priority to the following International Application: PCT Patent Application No. PCT/EP2005/002037 titled “Device For Adjusting The Angle Of A Component Than Can Be Rotated About A Rotational Axis, Especially The Arm Rest In A Vehicle” filed on Feb. 5, 2003, which claims priority to German Patent Application No. DE 102004011385.8 filed Mar. 5, 2004 (which are both incorporated by reference in their entirety).

### FIELD

The invention relates to a device for adjusting the angle of a component that can be rotated about a rotational axis, especially an arm rest, in particular fastened to a seat and in particular to or in a vehicle.

### BACKGROUND

Devices of this type are known to typically carry out various functions, in particular with respect to a component (e.g., armrest) in a motor vehicle: firstly, the component is to be able to be set in a more or less horizontal position in a manner such that it can easily be adjusted in accordance with the most comfortable or ergonomic position for a user; secondly, the component is also to be able to be set in a more or less vertical position, or in a position arranged parallel to the backrest of the seat, so that space for use by the user can be kept free, for example at the side of the seat, and is not taken up by the component; furthermore, the positions set are to be protected as reliably as possible against unintentional changes in setting. The terms “component” and “arm rest” are used largely synonymously below.

It is known to provide a more or less horizontal setting of an arm rest by providing a latching mechanism with a plurality of intermeshing teeth, so that a certain number of different, discrete positions of the arm rest is possible. Devices of this type are typically designed such that they are as small and compact as possible, which also reduces the weight and the production costs. In order to provide the desired functionality—in particular the provision of (1) a comfort region, in which the arm rest is to be locked essentially horizontally and dependent on the direction of rotation, (2) an unlocking region, which is provided between this comfort region and (3) an essentially vertical setting parallel to the backrest of a seat in which the arm rest is able to be set in an essentially freely moveable manner and may also be positioned back again into its lowermost position—automated solutions are known in general, in which control contours interact with moveable elements in such a manner that the functionality is achieved. In this respect, constrained guides are known which have the disadvantage that elements which move or are moveable relative to one another sometimes strike “hard” against one another and, as a result, the more sensitive of such elements may break or become worn or lose their functionality in some other way.

One object of the invention is therefore to provide a device for adjusting the angle of an arm rest in such a manner that the disadvantages of the prior art are avoided.

### SUMMARY

According to the invention, this object is achieved by a device for adjusting the angle of an arm rest that can be rotated about a rotational axis, the device having a first locking toothing and a rocking lever, the rocking lever being able to be set in a stable locking position and in a stable release position, the device having a control element acting on the spring at least in one angular position of the component. This avoids the disadvantages of the prior art because the rocking lever is not moved directly via the control element, with the result that, even at such a location, no excessive wear or even a breaking of the rocking lever can take place, and failures are very much more improbable. In this case, when changing the angular position of the component, a dynamic effect, starting from the control element, is exerted on the spring, this dynamic effect bringing about the adjustment of the rocking lever from its release position into its locking position. There is therefore no direct transmission of force or no direct contact between the control element and the rocking lever.

It is preferred that the device for setting the locking position and the release position of the rocking lever has a spring, in particular a snap-action spring which can be set into two stable positions. This has the advantage that the rocking lever can be set into its stable positions with very simple means. A spring of this type, in particular a snap-action spring or dead-center spring, is moreover comparatively lightweight and cost-effective, and robust and durable over the entire service life of the device.

Furthermore, it is preferred that the device has a control device, the control device bringing about a direction-of-rotation-dependent lockability of the component as a function of the angular position of the arm rest. It is thereby possible in a simple manner to permit the arm rest to be able to be locked only in certain angular-position regions, for example in a “comfort region” of the arm rest, which is provided in a more or less horizontal setting of the arm rest.

It is furthermore preferred that the first locking toothing is an internal toothing and the rocking lever has a second locking toothing forming an external toothing. A preferred device of this type can be constructed in a particularly simple and compact manner and with a comparatively low structural outlay such that it can be used very comfortably by a user of the device or of the arm rest. Although this preferred embodiment with an internal toothing on the first locking toothing and an external toothing on the second locking toothing is exclusively dealt with below, a design the other way around, i.e. with an internally toothed rocking lever, is also possible according to the invention.

Furthermore, it is preferred that the first locking toothing is a peripheral internal toothing, and that the control device, externally toothed, is arranged such that it interacts with the first locking toothing. This enables a cost-effective production of the device according to the invention in a simple manner because the internal toothing of the first locking toothing can be designed such that it is largely entirely peripheral. Furthermore, this simplifies the installation of the device according to the invention and therefore makes it more cost-effective.

The invention furthermore relates to an arm rest and a seat which have a device according to the invention or are assigned thereto.

### BRIEF DESCRIPTION OF THE FIGURES

The invention is explained in more detail below with reference to exemplary embodiments illustrated in the figures.

FIG. 1 shows a diagrammatic illustration of the various angular-position regions or angular regions which are relevant to the setting of the arm rest;

FIGS. 2 to 7 show the device according to one embodiment of the invention in different settings or angular positions of the arm rest.

FIG. 8 shows an exploded drawing of the device according to one embodiment of the invention.

### DETAILED DESCRIPTION

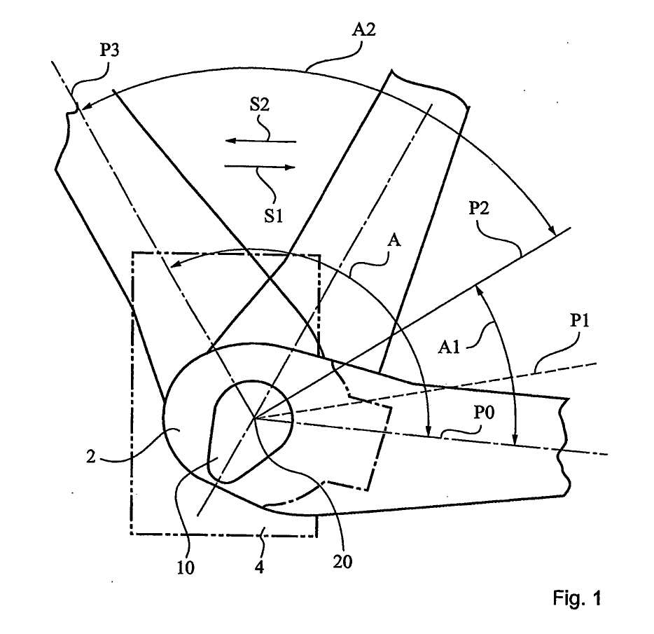

FIG. 1 illustrates an arm rest 2, which is arranged rotatably about a rotational axis 20, as an example of a component 2 or vehicle component 2. A device 10 connects the arm rest 2 to a seat 4 or to the backrest 4 of a seat. The seat 4, illustrated diagrammatically, can constitute, for example, the backrest of a seat or another device or component, for example of a motor vehicle. The terms “seat” and “backrest” are used largely synonymously below. In this case, the device 10 permits a plurality of settings or angular positions of the arm rest 2 relative to the backrest 4. The entire pivoting region A, which is determined by the device 10, of the arm rest 2 on the backrest 4 about the rotational axis 20 is divided into:

a) a first angular region Al which corresponds more or less to a horizontal setting of the arm rest 2 if it is assumed that the backrest 4 is positioned essentially vertically, and

b) a second angular region A2 which is arranged at the “upper end” of the pivoting region A following the first angular region A1.

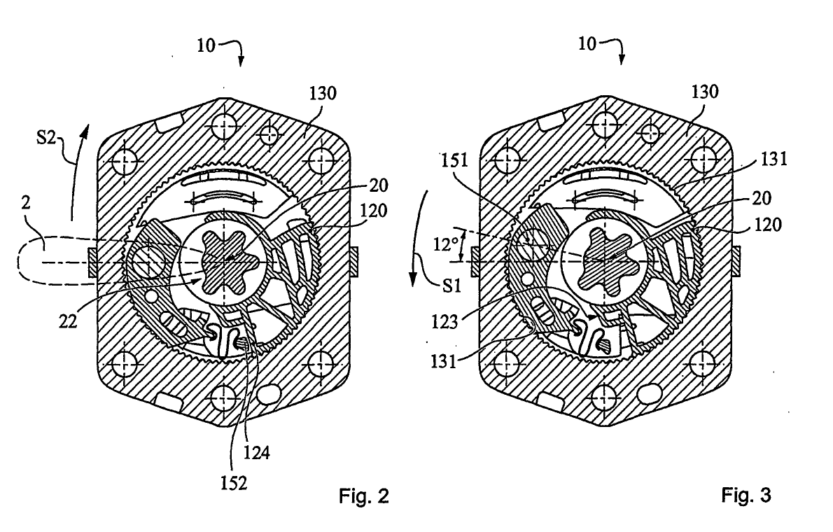

The first angular region A1, which is also referred to as the comfort region A1, extends between an extreme angular position P0 and a second angular position P2 marking the boundary between the first angular region A1 and the second angular region A2. A first angular position P1 is situated in or on the first angular region A1. A further extreme angular position P3 is provided at the end of the second angular region A2, i.e. at its end facing away from the first angular region. The entire pivoting range of the arm rest 2 is marked in FIG. 1 by the designation A. Furthermore, a first direction of rotation S1 in FIG. 1 and in all of the following figures is provided as a rotation of the arm rest 2 in the direction “downward” from the further extreme angular position P3 to the extreme angular position P0 (this is clockwise in FIG. 1 and counterclockwise in FIGS. 2 to 7), and a second direction of rotation S2 is provided for a rotation of the arm rest 2 counter to the direction of the first direction of rotation S1.

With, for example, a spring (not illustrated), provision can optionally be made according to one embodiment of the invention for the arm rest 2, at least in the second angular region A2, to be prestressed in the first direction of rotation S1, i.e. either such that a greater force is required in order to move the arm rest 2, at least in the second angular region A2, in the second direction of rotation S2 than to move the arm rest 2 in the first direction of rotation S1, or such that the arm rest 2 may move automatically in the direction of the first direction of rotation S1.

The sequence of movement and the functioning of the device 10 according to the invention or of the arm rest 2 according to the invention is explained in more detail below with reference to FIGS. 2 to 8.

FIGS. 2 to 7 illustrate various setting positions or angular positions of the arm rest 2 together with the device 10 and its various components. In this case, for the sake of simplicity, the arm rest 2 is not shown in any of FIGS. 3 to 7, with it being possible to recognize the position or angular position of the arm rest 2 by the fact that an axial contour 22 is not rotationally symmetrical and the arm rest 2 is always arranged in a rotationally fixed manner with respect to the axial contour 22.

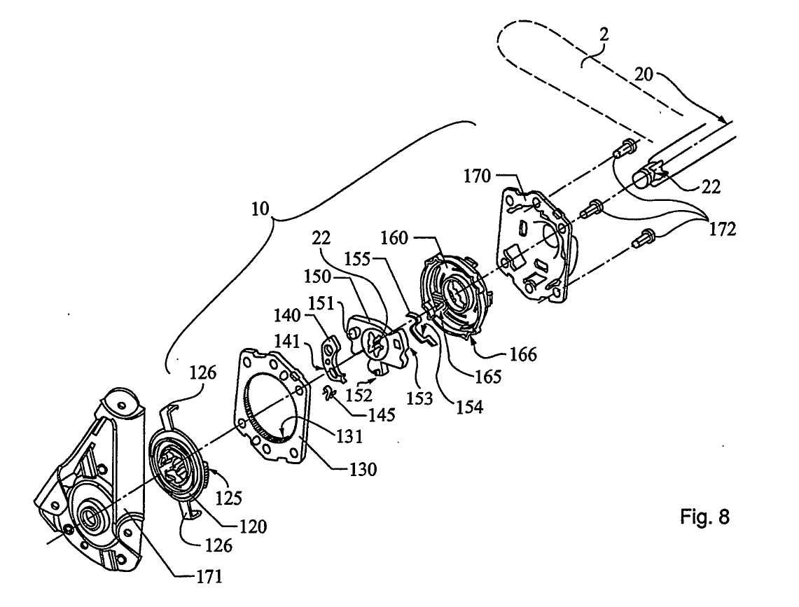

FIG. 8 illustrates the device 10 according to one embodiment of the invention together with the arm rest 2, the rotational axis 20, and a first housing part 170 of the device 10, a second housing part 171 of the device 10, and screws 172.

The various components of the device 10 according to embodiments of the invention are introduced below in common for FIGS. 2 to 8. In the interior of the device 10—as is apparent in particular from FIG. 8—the device 10 has a first locking toothing 131 which is fixed on a supporting element 130 and is provided as a preferably peripheral or continuous internal toothing of the supporting or retaining element 130.

A second locking toothing 141 of a rocking lever 140 interacts with the first locking toothing 131, with the rocking lever 140 being mounted rotatably or pivotably by means of a hole or recess (not specially designated by means of a designation) and by means of a pin 151 fastened to a rotational component 150. In this case, the pin 151 and the corresponding recess of the rocking lever 140 run parallel to the rotational axis 20, but offset parallel thereto, i.e. eccentrically. The rotational component 150, which is also designated the rotational element 150, has a recess corresponding to the axial contour 22 about the rotational axis 20, so that, after the axial contour 22 is inserted into the rotational component 150, the rotational component 150 is connected in a rotationally fixed manner to the arm rest 2. A rotation of the arm rest 2 about the rotational axis 20 therefore brings about a rotation of the rotational element 150 which carries along the rocking lever 140. The rocking lever 140 is connected by means of a spring 145 (which may be designed as a snap-action spring, i.e., as a dead-center spring) to the rotational element 150, or interacts with the latter in such a manner that the rocking lever 140 can be set into two stable positions, namely a stable locking position and a stable release position. The stable locking position of the rocking lever 140 corresponds here to the position of the rocking lever 140 that is illustrated in FIGS. 2 to 4. The release position of the rocking lever 140 corresponds to the positions of the rocking lever 140 that are illustrated in FIGS. 5 to 7. In the locking position of the rocking lever 140, the second locking toothing 141 is in this case arranged further outward (with respect to the rotational axis 20), and, in the release position of the rocking lever 140, the further locking toothing 141 is arranged further inward, i.e. closer to the rotational axis 20. The rocking lever 140 is arranged in the plane of the retaining element 130, i.e. in the plane of the first locking toothing 131. Likewise arranged in this plane is at least part of a control device 120 which can be locked into the supporting element retaining element 130, for example by means of a clip-type latching 126 (see FIG. 8). For this purpose, the control device 120 has, at least in a partial region, a toothing 125 which interacts with the first locking toothing 131, at least in partial regions of its circumference, and thereby connects the control device 120 to the retaining element 130 (in a rotationally fixed manner). Of course, the control device 120 and the retaining element 130 could also be produced in an integrated manner according to an alternative embodiment.

On that side of the retaining element 130 which lies opposite the control device 120, a further retaining element 160 is provided which has a recess 165 for receiving part of a locking spring 155, the locking spring having a fifth control element 154 which interacts with a sixth control element 153 of the rotational component 150 and—as shown in FIG. 7—brings about a locking of the rotational element 150 if the arm rest 2 is set in its further extreme position P3. The further retaining element 160 also serves, by means of friction elements 166, to provide a certain resistance to the movement of the arm rest 2 about the rotational axis 20. This is advantageous in so far as an unintentional adjustment of the arm rest 2, for example caused by up and down movements of the vehicle in the case of undulating terrain, is thereby prevented. As an alternative to the friction elements 166, provision may also be made for the arm rest 2 to be prestressed in the direction of the extreme position P0 by means of, for example, a spring (not illustrated).

The housing elements 171, 170, 172 are not illustrated in FIGS. 2 to 7 for the sake of simplicity.

The sequence of movement and the functioning of the device 10 and the arm rest 2 according to various embodiments of the invention are explained in more detail with reference to FIGS. 2 to 7.

It is to be assumed in FIG. 2 that the arm rest 2 is essentially in its extreme angular position P0 illustrated in FIG. 1. In the extreme angular position P0, the rocking lever 140 is set in its locking position. This results in the engagement between the first locking toothing 131 (of the supporting element 130) and the second locking toothing 141 of the rocking lever 140. In this position, the arm rest 2 is locked in a manner dependent on the direction of rotation. This means that although the arm rest 2 can be moved upward, i.e. in the second direction of rotation S2 (counter to a certain dynamic effect), the arm rest 2 is completely locked with respect to a movement in the direction of the first direction of rotation S1. If the arm rest 2 is moved in the direction of the second direction of rotation S2, i.e. “upward”, the engagement of the locking toothings 131, 141 is initially canceled. However, the latter then snap into place again under the action of the spring 145 which prestresses the rocking lever 140 in the direction of its locking position, so that the locking toothings 131, 141—displaced by at least one tooth—come into engagement again. In this mariner, it is possible for the arm rest 2 to be lockable in accordance with the discrete latching positions, which are predetermined by the locking toothings 131, 141, in the comfort region. In other words, between the extreme angular position P0 and an angle of approximately 40° in the direction of the second direction of rotation S2, armrest 2 is lockable in a manner dependent on the direction of rotation, i.e. although the arm rest 2 can be moved upward, it cannot be moved downward.

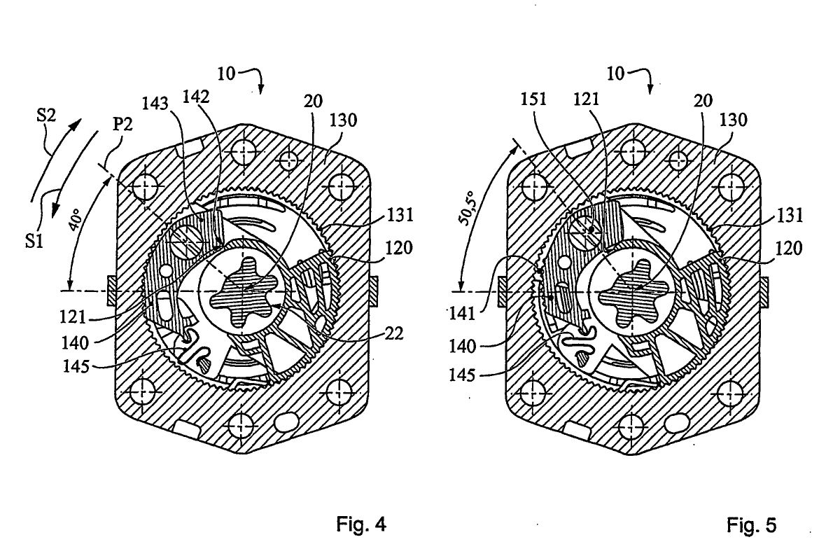

In FIG. 4, the arm rest 2 is set in the second angular position in which a region 142 of the side 143, which lies opposite the second locking toothing 141, of the rocking lever 140, which is designed as a two-sided lever, is moved by a first control element 121 of the control device 120 in such a manner that the rocking lever 140 pivots over from its locking position into its release position, which is illustrated in FIG. 5.

In FIG. 5, the arm rest 2 is moved upward by approx. 50.5° in relation to its extreme angular position P0, i.e. in the second direction S2. In this position of the arm rest 2, the rocking lever 140 is set securely into its release position, i.e. the first control element 121 of the control device 120 has pressed that side 143 of the rocking lever 140 which lies opposite the second locking toothing 141 outward (away from the rotational axis 20), so that the other side of the rocking lever 140, on which the second locking toothing 141 is arranged, is pressed inward (i.e. toward the rotational axis 20), with the spring 145 being moved into a second snap-in position which corresponds to the release position of the rocking lever 140.

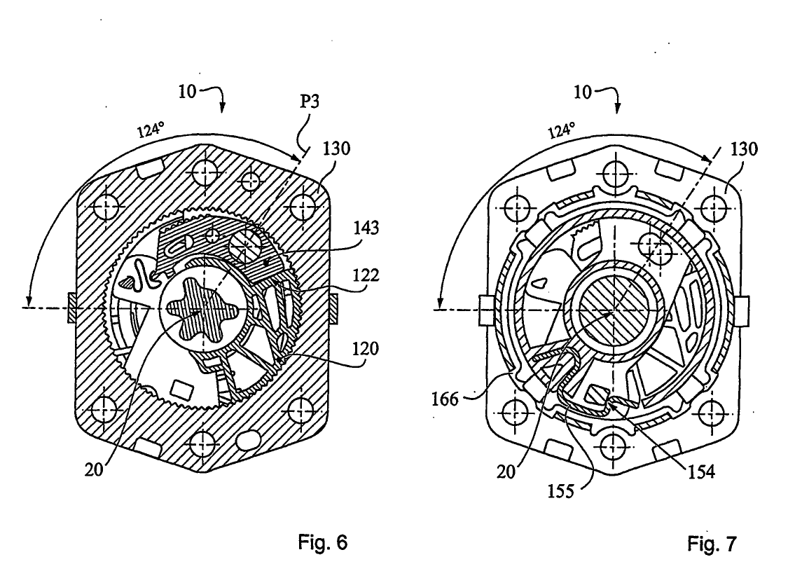

If the arm rest 2 is rotated further, as illustrated in FIG. 6, it reaches an end stop in the further extreme angular position P3 (for example, if rotated 124 degrees from the extreme angular position P0). In this case, that end 143 of the rocking lever 140 which is opposite the second locking toothing 141 strikes against a second control element 122 of the control device.120. The second control element 122 may be designed as a rectilinear stop for the end 143 of the rocking lever 140. The arm rest 2 is essentially freely rotatable between the second angular position P2 and the further extreme angular position P3, this free rotatability being restricted, if appropriate, by braking elements 166, which can be seen in FIG. 8 and in FIG. 7, and/or by a spring prestressing (not illustrated) in the direction of the extreme angular position P0 of the arm rest 2.

FIG. 7 also illustrates the retaining clip 155 together with the fifth control element 154.

If the arm rest 2 is rotated back again in the direction of the extreme angular position P0, the rocking lever 140, which is set into its release position, reaches, at approx. 12 degrees of rotation (upward in relation to the extreme angular position P0), a point or a position at which a third control element 123 (illustrated in FIG. 3) of the control device 120 acts on the spring 145 and brings the latter to set the rocking lever 140 from its release position into its locking position. A fourth control element 124 of the control device 120 is illustrated in FIG. 2. Its effect is, in the extreme angular position P0, to form a stop for the rotational component 50 or a stop element 152 fastened to the rotational component 150. After the engagement between the first locking toothing 131 and the second locking toothing 141 is produced in the extreme angular position P0 by the effect of the third control element 123, the arm rest 2 is again locked in a manner dependent on the direction of rotation and can be set in the comfort region between the extreme angular position P0 and the second angular position P2. It is thereby possible for the arm rest 2 to be locked in a manner dependent on the direction of rotation without additional buttons (e.g., automatically in its comfort region, which corresponds to the first angular region A1), and to likewise be automatically unlocked if the arm rest 2 is set beyond this comfort region into the second angular region A2. According to another embodiment of invention, it is not necessary to set the arm rest as far as its upper stop, i.e. as far as its further extreme angular position P3, in order to bring about an unlocking or the setting of the release position of the rocking lever 140. It may be particularly advantageous that, during the transfer of the rocking lever 140 from its release position into its locking position, a control contour does not interact “hard” with the rocking lever 140 or with another actuating element, thus largely avoiding the probability of breakages or of material wear, in particular under dynamic effects. According to one embodiment of the invention, it is, however, also possible to move the setting of lever 140 from its release position into its locking position to take place by the third control element 123 not merely interacting with the spring 145 but rather interacting directly with the rocking lever 140.

It is clear that provision is made according to one embodiment of the invention for the spring 145 to exert a sufficiently large force on the rocking lever such that, firstly, a bistable position of the rocking lever 140 is brought about in conjunction with the geometry of the rocking lever 140 and that, secondly, even during the ratchet function in the comfort region A1, a sufficiently high press-on force against the teeth of the first and second locking toothings 131, 141 is ensured.

1. A device for adjusting the angle of a component, comprising: a first locking toothing; a rocking lever, the rocking lever being able to be set in a stable locking position and in a stable release position; and a control element acting on a spring in at least one angular position of the component.

2. The device as claimed in claim 1, wherein the spring can be set into two stable positions for setting the locking position and the release position of the rocking lever.

3. The device as claimed in claim 1, further comprising: a control device, the control device bringing about a direction-of-rotation-dependent lockability of the component as a function of the angular position of the component.

4. The device 3 as claimed in claim 1, wherein the first locking toothing is an internal toothing and the rocking lever has a second locking toothing forming an external toothing.

5. The device as claimed in claim 1, wherein the first locking toothing is a peripheral internal toothing, and the control device, is externally toothed and arranged such that it interacts with the first locking toothing.

6. The device as claimed in claim 1, wherein the component is an armrest.

7. The device as claimed in claim 6, wherein the component is an armrest for a vehicle seat.

8. The device as claimed in claim 2, wherein the spring is a snap-action spring.

9. A locking mechanism for an armrest, comprising:
a first component having a plurality of external teeth, the first component being configured to rotate through a range of rotation relative to a second component having a set of internal teeth; and
a spring mounted on the first component and configured to selectively bias the external teeth toward the internal teeth;
wherein the first component is releasably lockable in at least two positions wherein the external teeth at least partially engage the internal teeth; and
wherein the first component is freely rotatable through at least a portion of the range of rotation.

10. The locking mechanism of claim 9, wherein the first component further comprises:
a rocking lever rotatably coupled to a rotational element, wherein the external teeth are located on the rocking lever, and the spring selectively biases the external teeth via the rocking lever.

11. The locking mechanism of claim 9, further comprising a control device, the control device limiting the range of rotation of the first component.

12. The locking mechanism of claim 11, wherein the control device is fixed relative to the second component.

13. The locking mechanism of claim 11, wherein the control device prevents engagement of the internal teeth and the external teeth through at least a portion of the range of rotation such that the first component may rotate freely with respect to the second component.

14. The locking mechanism of claim 11, wherein the control device includes a first surface and a recess, the range of rotation of the first component being defined by the angular displacement of the first surface from the recess.

15. The locking mechanism of claim 14, wherein the recess includes a spring member to releasably lock the first component.

16. The locking mechanism of claim 9, wherein the spring is a snap-action spring.

17. The locking mechanism of claim 9, wherein the spring has at least a first stable position and a second stable position, and wherein the spring is moved from the first stable position to the second stable position by engaging a projection on the control device.

18. The locking mechanism of claim 17, wherein the spring biases the external teeth toward the internal teeth when the spring is in the second position.

19. An adjustable vehicle seat, comprising:
an armrest rotatably coupled to a seat portion;
means for constraining the range of rotation of the armrest with respect to the seat portion between a first position and a third position;
means for releasably locking the armrest at a plurality of positions between the first position and a second position, the second position being located at an intermediate position in the range of rotation between the first position and the second position; and
means for freely rotating the armrest from the second position to the third position.

20. The adjustable vehicle seat of claim 19, further comprising:
means for releasably locking the armrest in the third position.
